(19) United States
(12) Patent Application Publication
(10) Pub. No.: US 2005/0146160 A1
(43) Pub. Date: Jul. 7, 2005

(54) Home utility management vehicle mini van or HUM V Mini Van

(76) Inventor: Michael Lawrence Beauchamp, San Francisco, CA (US)

Correspondence Address: Mr. Michael L. Beauchamp, 651-B Minna Street, San Francisco, CA, 94103, US

(21) Appl. No.: 11/013,942

(22) Filed: Dec. 15, 2004

Related U.S. Application Data
(60) Provisional application No. 60/503,867, filed on Dec. 18, 2003.

(51) Int. Cl. B60J 5/06

(52) U.S. Cl. 296/155

(57) ABSTRACT

A large utility sport passenger van featuring the passenger side sliding door, bottom mounted scuff plate, truck wheel wells, conical hood dash and windshield, all-terrain tires, occupant safety features, capable of high-speed performance, off-road, rough-terrain transport, low, high or level angle 360 degree picture-taking, surveillance-maneuvering, on-the-fly pick-up, and rescue.

### BACKGROUND OF THE INVENTION

1. Field of the Invention

This invention genesis pertains to occupant safety features, which for the first time enables occupants of a utility sport passenger van to open or close a passenger door without reaching their arm or hand outside the vehicle body, and to open and close said sliding door while in motion over rough-terrain, even at accelerated speeds.

2. Description of Prior Art

Prior to now utility sport passenger van with a conical glare reducing hood, dash, and windshield are unable to compete or demonstrate high-performance all-terrain maneuvers while opening and closing a side sliding door. A utility sport passenger van with a sliding door has the advantage of being able to transport people and/or equipment over all-terrain conditions while at the same time providing the means to pick-up, rescue or pin-point targets while in motion without leaving the confines of the vehicle body or creating speed reducing aerodynamic drag with a conventional hinge door. It is possible also thanks to my invention for children to close the door of a utility sport passenger van without reaching outside the vehicle body. The conical front end and windshield of a utility sport passenger van further results in less glare off the hood lid, and greater visibility, enhancing via all-terrain transport.

### SUMMARY OF THE INVENTION

Inheritantly, I have invented the home utility management vehicle mini van or HUM V Mini Van, which is a utility sport passenger van, a configuration particularly useful featuring the side sliding door and bottom mounted scuff plate, occupant safety features, which combine the advantages of the sport utility vehicle with the advantages of the passenger van, enabling high-speed performance, off-road, rough-terrain transport, high, low and eye level 360, degree picture-taking and survalance-manuvering, on-the-fly pick-up, and rescue.

### BRIEF DESCRIPTION OF THE DRAWING

FIG. 1 is a side view of the home utility management vehicle mini van or Hum V Mini Van, traveling in rapid motion over rough-terrain; while the side sliding door in the open position allows a 35 mm camera to extend on a robotic arm for a level angle shoot.

### DETAILED DESCRIPTION OF THE INVENTION AND DRAWING

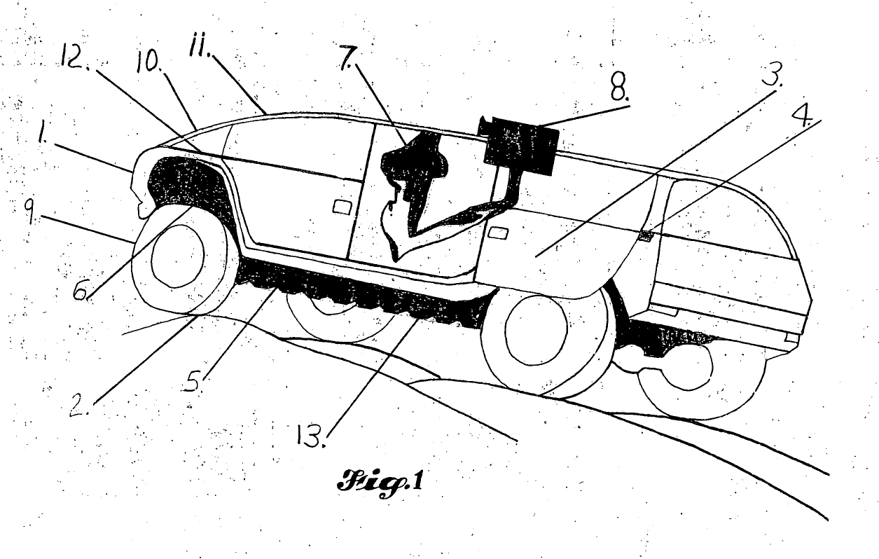

FIG. 1 depicts the Home Utility Management Vehicle Mini Van or HUM V Mini Van 1, accelerating over rough-terrain 2. The sliding door 3, and visible sliding door track end 4, are shown in the open position, while the bottom-mounted scuff plate 5, and large truck wheel wells 6, protect and enable the passenger van to off-road maneuver. In this case a robotic arm 7, and a 35 mm camera 8, are extended through the sliding door opening, allowing the driver of the HUM V Mini Van to shoot high, low or level angle pictures, all while 2. in motion over rough-terrain and from the convenience of the drivers seat. 9, are all-terrain tires. 10, and 11, are two half portions of a single continuous piece of tempered glass forming the windshield. 12, is the dash above the hood lid. 13, is the bottom-mounted scuff-plate rock shattering waffle head points.

1. The home utility management vehicle mini van or HUM V Mini Van where a passenger van is constructed with a side sliding door, bottom mounted scuff plate, sport utility chassis and truck wheel wells and all-terrain tires; a conical hood, dash and windshield covering the front end of the utility sport chassis.

2. The home utility management vehicle mini van or HUM V Mini Van where a remote controlled sliding door allows the driver of said vehicle to open and close the side sliding door while driving the vehicle over rough-terrain, performing on-the-fly pick-ups and rescues.

3. The home utility management vehicle mini van or HUM V Mini Van where a robotic arm controls a 35 mm camera able to take pictures at the vehicle drivers command, on high, low or level angles in a 360 degree area and while in motion, by extending and retracting through the side sliding door.

4. The rock shattering waffle-head pointed bottom-mounted scuff-plate.
